(19) United States
(12) Patent Application Publication
(10) Pub. No.: US 2012/0087531 A1
(43) Pub. Date: Apr. 12, 2012

(54) ULTRASONICALLY WELDED STRUCTURES AND METHODS FOR MAKING THE SAME

(75) Inventors: M. Evans Hankey, San Francisco, CA (US); Jeff Hayashida, San Francisco, CA (US); Jonathan Aase, Redwood City, CA (US); Rico Zorkendorfer, San Francisco, CA (US)

(73) Assignee: APPLE INC., Cupertino, CA (US)

(21) Appl. No.: 13/107,314

(22) Filed: May 13, 2011

Related U.S. Application Data
(60) Provisional application No. 61/390,935, filed on Oct. 7, 2010.

(51) Int. Cl. H04R 1/10; B32B 38/00; B32B 38/10; B32B 38/16; B32B 37/02; B32B 37/14

(52) U.S. Cl. 381/370; 156/73.1

(57) ABSTRACT

Ultrasonically welded structures and methods for manufacturing welded structures are disclosed. The welded structures can be earbuds or headphones.

### CROSS-REFERENCE TO RELATED APPLICATION

This application claims the benefit of previously filed U.S. Provisional Patent Application No. 61/390,935, filed Oct. 7, 2010, entitled “ULTRASONICALLY WELDED STRUCTURES AND METHODS FOR MAKING THE SAME,” which is incorporated by reference herein in its entirety.

### BACKGROUND

Wired headsets are commonly used with many portable electronic devices such as portable music players and mobile phones. Headsets can include non-cable components such as a jack, headphones, and/or a microphone and one or more cables that interconnect the non-cable components. Cable and non-cable components are typically connected together such that interfaces between components are abrupt and aesthetically displeasing. Likewise, individual cable and non-cable components are typically constructed of several discrete components that are joined together in an abrupt and aesthetically displeasing fashion. Accordingly, what are needed are headsets with seamless non-cable components and cable components that seamlessly integrate with the non-cable components.

### SUMMARY

Ultrasonically welded structures and methods for manufacturing welded structures are disclosed. The welded structures can be earbuds or headphones.

Headphones may be included as part of a headset that can connect to portable electronic devices. Headsets may include other non-cable components such as a jack and/or microphone and one or more cables that interconnect the non-cable components. According to some embodiments, aesthetically pleasing, seamless non-cable components are disclosed. For example, headphone components are disclosed that appear to have been constructed as a seamless unibody structure.

Seamless headphones may be ultrasonically welded such that the welding produces an unpolished welded structure. A portion of the unpolished welded structure can be cut to a predetermined size, sanded, polished, and cleaned to provide a seamless polished headphone component.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIGS. 1A and 1B illustrate different headsets having a cable structure that seamlessly integrates with non-cable components in accordance with some embodiments of the invention;

FIG. 2 shows different views of an illustrative headphone constructed in accordance with an embodiment of the invention;

FIG. 3 shows illustrative views of a headphone having an overflowed weld ring in accordance with embodiments of the invention;

FIG. 4 shows illustrative cross-sectional views of top and bottom components of a headphone in accordance with embodiments of the invention;

FIG. 5 shows illustrative a cross-sectional view of an unpolished headphone welded together in accordance with an embodiment of the invention; and

FIG. 6 shows illustrative steps for making a welded structure in accordance with an embodiment of the invention.

### DETAILED DESCRIPTION OF THE DISCLOSURE

Ultrasonically welded structures and methods for manufacturing welded structures are disclosed. The welded structures can be earbuds or headphones. The headphones can be constructed from two different component pieces welded together. A weld ring may be formed during the welding process that can be cut, sanded, polished, and cleaned to produce a headphone that appears to be of one-piece or unibody construction. One or both of the component pieces that make up a unibody headphone can contain electronic headphone components (e.g., a speaker and circuit board) that can interface with a cable structure as part of a headset.

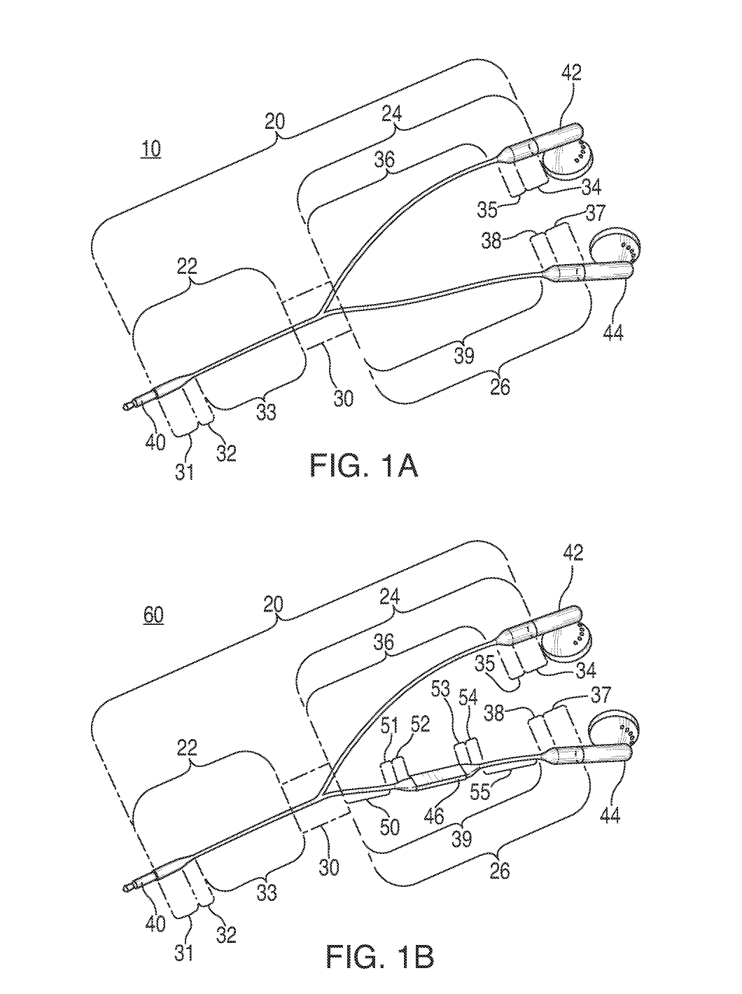

FIG. 1A shows an illustrative headset 10 having cable structure 20 that seamlessly integrates with non-cable components 40, 42, 44. For example, non-cable components 40, 42, and 44 can be a male plug, a left headphone, and a right headphone, respectively. Cable structure 20 has three legs 22, 24, and 26 joined together at bifurcation region 30. Leg 22 may be referred to herein as main leg 22, and includes the portion of cable structure 20 existing between non-cable component 40 and bifurcation region 30. In particular, main leg 22 includes interface region 31, bump region 32, and non-interface region 33. Leg 24 may be referred to herein as left leg 24, and includes the portion of cable structure 20 existing between non-cable component 42 and bifurcation region 30. Leg 26 may be referred to herein as right leg 26, and includes the portion of cable structure 20 existing between non-cable component 44 and bifurcation region 30. Both left and right legs 24 and 26 include respective interface regions 34 and 37, bump regions 35 and 38, and non-interface regions 36 and 39.

Legs 22, 24, and 26 generally exhibit a smooth surface throughout the entirety of their respective lengths. Each of legs 22, 24, and 26 can vary in diameter, yet still retain the smooth surface.

Non-interface regions 33, 36, and 39 can each have a predetermined diameter and length. The diameter of non-interface region 33 (of main leg 22) may be larger than or the same as the diameters of non-interface regions 36 and 39 (of left leg 24 and right leg 26, respectively). For example, leg 22 may contain a conductor bundle for both left and right legs 24 and 26 and may therefore require a greater diameter to accommodate all conductors. In some embodiments, it is desirable to manufacture non-interface regions 33, 36, and 39 to have the smallest diameter possible, for aesthetic reasons. As a result, the diameter of non-interface regions 33, 36, and 39 can be smaller than the diameter of any non-cable component (e.g., non-cable components 40, 42, and 44) physically connected to the interfacing region. Since it is desirable for cable structure 20 to seamlessly integrate with the non-cable components, the legs may vary in diameter from the non-interfacing region to the interfacing region.

Bump regions 32, 35, and 38 provide a diameter changing transition between interfacing regions 31, 34, and 37 and respective non-interfacing regions 33, 36, and 39. The diameter changing transition can take any suitable shape that exhibits a fluid or smooth transition from any interface region to its respective non-interface region. For example, the shape of the bump region can be similar to that of a cone or a neck of a wine bottle. As another example, the shape of the taper region can be stepless (i.e., there is no abrupt or dramatic step change in diameter, nor a sharp angle at an end of the bump region). Bump regions 32, 35, and 38 may be mathematically represented by a bump function, which requires the entire diameter changing transition to be stepless and smooth (e.g., the bump function is continuously differentiable).

Interface regions 31, 34, and 37 can each have a predetermined diameter and length. The diameter of any interface region can be substantially the same as the diameter of the non-cable component it is physically connected to, to provide an aesthetically pleasing seamless integration. For example, the diameter of interface region 31 can be substantially the same as the diameter of non-cable component 40. In some embodiments, the diameter of a non-cable component (e.g., component 40) and its associated interfacing region (e.g., region 31) are greater than the diameter of the non-interface region (e.g., region 33) they are connected to via the bump region (e.g., region 32). Consequently, in this embodiment, the bump region decreases in diameter from the interface region to the non-interface region.

In another embodiment, the diameter of a non-cable component (e.g., component 40) and its associated interfacing region (e.g., region 31) are less than the diameter of the non-interface region (e.g., region 33) they are connected to via the bump region (e.g., region 32). Consequently, in this embodiment, the bump region increases in diameter from the interface region to the non-interface region.

The combination of the interface and bump regions can provide strain relief for those regions of headset 10. In one embodiment, strain relief may be realized because the interface and bump regions have larger dimensions than the non-interface region and thus are more robust. These larger dimensions may also ensure that non-cable portions are securely connected to cable structure 20. Moreover, the extra girth better enables the interface and bump regions to withstand bend stresses.

The interconnection of legs 22, 24, and 26 at bifurcation region 30 can vary depending on how cable structure 20 is manufactured. In one approach, cable structure 20 can be a single-segment unibody cable structure. In this approach all three legs are manufactured jointly as one continuous structure and no additional processing is required to electrically couple the conductors contained therein. That is, none of the legs are spliced to interconnect conductors at bifurcation region 30, nor are the legs manufactured separately and then later joined together. Some single-segment unibody cable structures may have a top half and a bottom half, which are molded together and extend throughout the entire unibody cable structure. For example, such single-segment unibody cable structures can be manufactured using injection molding and compression molding manufacturing processes (discussed below in more detail). Thus, although a mold-derived single-segment unibody cable structure has two components (i.e., the top and bottom halves), it is considered a single-segment unibody cable structure for the purposes of this disclosure. Other single-segment unibody cable structures may exhibit a contiguous ring of material that extends throughout the entire unibody cable structure. For example, such a single-segment cable structure can be manufactured using an extrusion process.

In another approach, cable structure 20 can be a multi-segment unibody cable structure. A multi-segment unibody cable structure may have the same appearance of the single-segment unibody cable structure, but the legs are manufactured as discrete components. The legs and any conductors contained therein are interconnected at bifurcation region 30. The legs can be manufactured, for example, using any of the processes used to manufacture the single-segment unibody cable structure.

The cosmetics of bifurcation region 30 can be any suitable shape. In one embodiment, bifurcation region 30 can be an overmold structure that encapsulates a portion of each leg 22, 24, and 26. The overmold structure can be visually and tactically distinct from legs 22, 24, and 26. The overmold structure can be applied to the single or multi-segment unibody cable structure. In another embodiment, bifurcation region 30 can be a two-shot injection molded splitter having the same dimensions as the portion of the legs being joined together. Thus, when the legs are joined together with the splitter mold, cable structure 20 maintains its unibody aesthetics. That is, a multi-segment cable structure has the look and feel of single-segment cable structure even though it has three discretely manufactured legs joined together at bifurcation region 30. Many different splitter configurations can be used, and the use of some splitters may be based on the manufacturing process used to create the segment.

Cable structure 20 can include a conductor bundle that extends through some or all of legs 22, 24, and 26. Cable structure 20 can include conductors for carrying signals from non-cable component 40 to non-cable components 42 and 44

Non-cable components 42 and 44 can be seamless, unibody headphones. A unibody headphone may be composed of two separate headphone components. According to some embodiments, one component can contain headphone components (e.g., speaker(s) and a circuit board that can connect to cable structure 20), while the other component can have ports to allow sound to be readily transmitted from the headphone. The two components can be welded together such that no air bubbles remain and gaps between the two components are completely filled in. The weld ring created at the interface of the two components can then be cut, sanded, polished, and cleaned, resulting in a headphone that appears to be of one-piece or unibody construction.

Cable structure 20 can include one or more rods constructed from a superelastic material. The rods can resist deformation to reduce or prevent tangling of the legs. The rods are different than the conductors used to convey signals from non-cable component 40 to non-cable components 42 and 44, but share the same space within cable structure 20. Several different rod arrangements may be included in cable structure 20.

In yet another embodiment, one or more of legs 22, 24, and 26 can vary in diameter in two or more bump regions. For example, the leg 22 can include bump region 32 and another bump region (not shown) that exists at leg/bifurcation region 30. This other bump region may vary the diameter of leg 22 so that it changes in size to match the diameter of cable structure at bifurcation region 30. This other bump region can provide additional strain relief.

In some embodiments, another non-cable component can be incorporated into either left leg 24 or right leg 26. As shown in FIG. 1B, headset 60 shows that non-cable component 46 is integrated within leg 26, and not at an end of a leg like non-cable components 40, 42 and 44. For example, non-cable component 46 can be a communications box that includes a microphone and a user interface (e.g., one or more mechanical or capacitive buttons). Non-cable component 46 can be electrically coupled to non-cable component 40, for example, to transfer signals between communications box 46 and one or more of non-cable components 40, 42 and 44.

Non-cable component 46 can be incorporated in non-interface region 39 of leg 26. In some cases, non-cable component 46 can have a larger size or girth than the non-interface regions of leg 26, which can cause a discontinuity at an interface between non-interface region 39 and communications box 46. To ensure that the cable maintains a seamless unibody appearance, non-interface region 39 can be replaced by first non-interface region 50, first bump region 51, first interface region 52, communications box 46, second interface region 53, second bump region 54, and second non-interface region 55.

Similar to the bump regions described above in connection with the cable structure of FIG. 1A, bump regions 51 and 54 can handle the transition from non-cable component 46 to non-interface regions 50 and 55. The transition in the bump region can take any suitable shape that exhibits a fluid or smooth transition from the interface region to the non-interface regions. For example, the shape of the taper region can be similar to that of a cone or a neck of a wine bottle.

Similar to the interface regions described above in connection with the cable structure of FIG. 1A, interface regions 52 and 53 can have a predetermined diameter and length. The diameter of the interface region is substantially the same as the diameter of non-cable component 46 to provide an aesthetically pleasing seamless integration. In addition, and as described above, the combination of the interface and bump regions can provide strain relief for those regions of headset 10.

In some embodiments, non-cable component 46 may be incorporated into a leg such as leg 26 without having bump regions 51 and 54 or interface regions 52 and 53. Thus, in this embodiment, non-interfacing regions 50 and 55 may be directly connected to non-cable component 46.

Cable structures 20 can be constructed using many different manufacturing processes. The processes discussed herein include those that can be used to manufacture the single-segment unibody cable structure or legs for the multi-segment unibody cable structure. In particular, these processes include injection molding, compression molding, and extrusion. Embodiments of this invention use compression molding processes to manufacture a single-segment unibody cable structure or multi-segment unibody cable structures.

In one embodiment, a cable structure can be manufactured by compression molding two urethane sheets together to form the sheath of the cable structure. Using this manufacturing method, the finished cable structure has a bi-component sheath that encompasses a resin and a conductor bundle. The resin further encompasses the conductor bundle and occupies any void that exists between the conductor bundle and the inner wall of the bi-component cable. In addition, the resin secures the conductor bundle in place within the bi-component sheath.

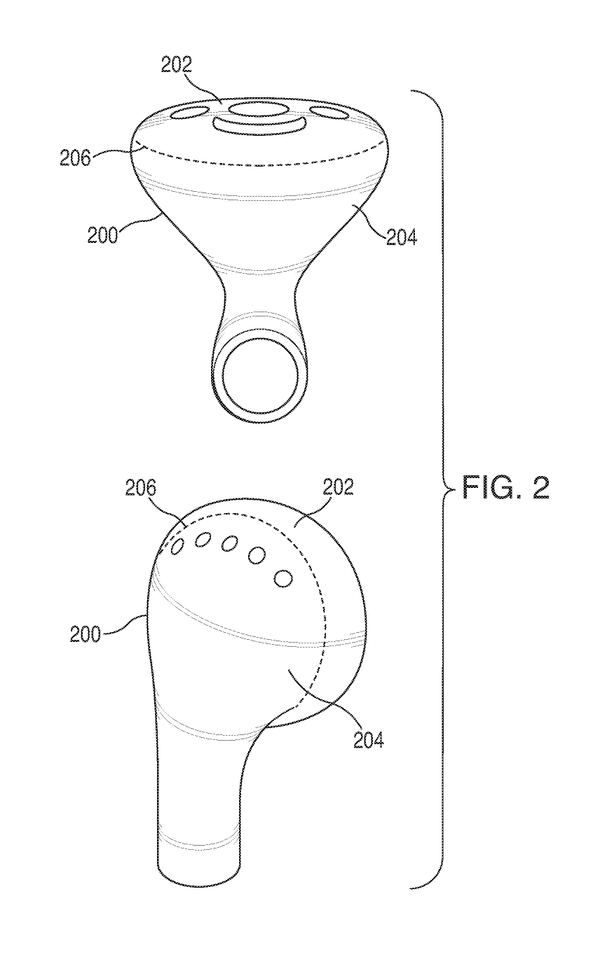

FIG. 2 shows different views of an illustrative headphone constructed in accordance with an embodiment of the invention. As shown, headphone 200 aesthetically appears to be a one-piece or unibody construction even though it is constructed from top component 202 and bottom component 204. A dashed line is shown to indicate the junction between top and bottom components 202 and 204. Polished weld ring 206 exists over the dashed line and seamlessly blends in with the surface of both top and bottom components 202 and 204 to provide the one-piece appearance. In addition, polished weld ring 206 represents the weld that mates top and bottom components 202 and 204 together.

Top component 202 can be a cap having one or more ports that is affixed to bottom component 204. In some embodiments, top component can include a screen to prevent debris from entering the ports. Bottom component 204 can be a housing that contains headphone components (e.g., speaker(s) and circuit board) and can interface with a cable structure. Top and bottom components 202 and 204 may be constructed from the same material or from different materials. In one embodiment, components 202 and 204 may be constructed from a plastic material.

Polished weld ring 206 is derived from top component 202, bottom component 204, or both components 202 and 204. That is, when top and bottom components 202 and 204 are welded together, a portion of either or both components 202 and 204 melt to form an overflowed weld ring around the junction. This overflowed ring can be cut, sanded, polished, and buffed to form polished weld ring 206.

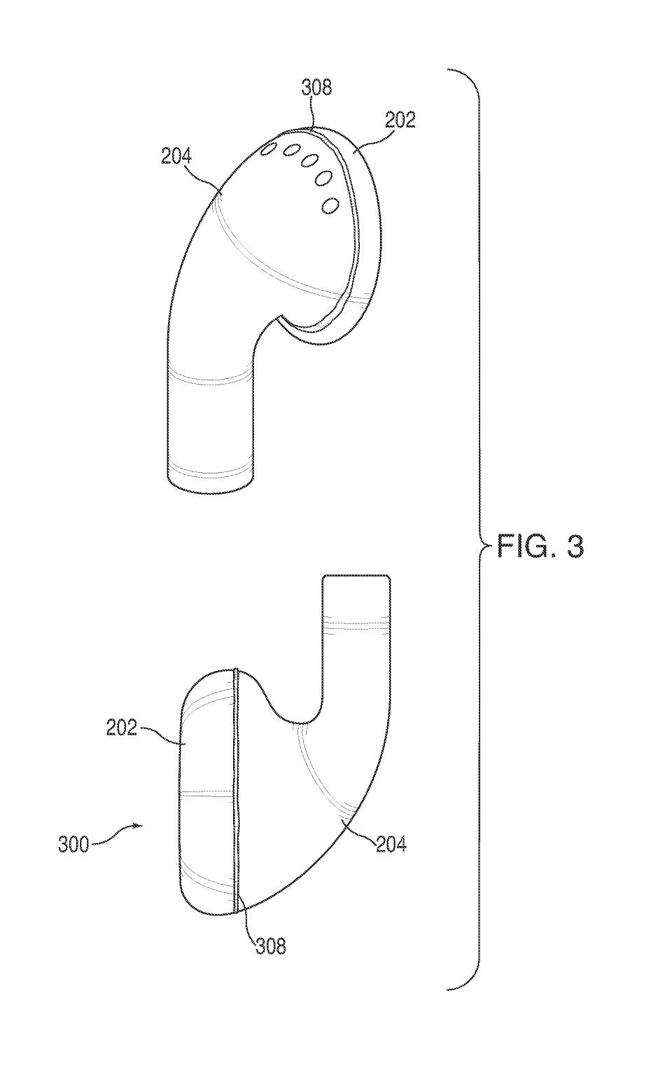

FIG. 3 shows illustrative views of headphone 300 having overflowed weld ring 308 in accordance with embodiments of the invention. This view shows headphone 300 after components 202 and 204 have been ultrasonically welded together. Headphone 300 shows top and bottom components 202 and 204 joined together at overflowed weld ring 308. As shown, overflowed weld ring completely encircles welded headphone 300.

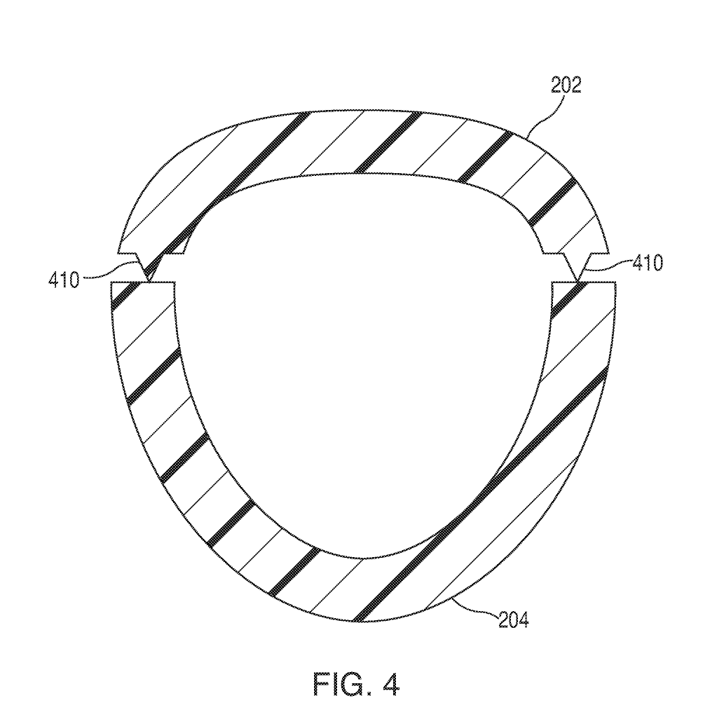

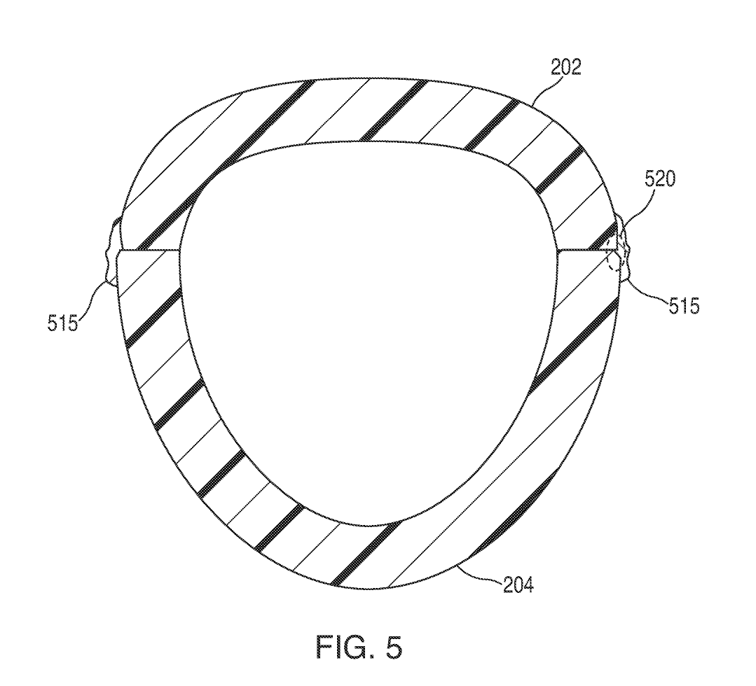

FIG. 4 shows illustrative cross-sectional views of top and bottom components 202 and 204 in accordance with embodiments of the invention. Any circuitry that may be contained within components 202 and 204 have been omitted to avoid overcrowding the drawing. Top component 202 includes flow control element 410. Flow control element 410 is part of component 202 and is positioned and shaped to promote a directed flow of melt material during a welding process. As will be explained in more detail below, it is desirable for the melt material to flow to the outside surface of components 202 and 204 to form an overflowed weld ring (shown as overflowed weld ring 515 in FIG. 5).

Flow control element 410 may exist at all points of an interface region of component 202. In one embodiment, the illustrative triangle shape of element 410 may form a continuous raised ring around the interface region of component 202. The interface regions of components 202 and 204 are the regions that weld together during a welding process. In another embodiment, element 410 may exist in discrete portions around the interface portion of component 202. It is understood that bottom component 204 can include flow control element 410 in lieu of, or in addition to, component 202.

In addition to whether element 410 is provided in continuous or discrete form around the interface region, the position of element 410 relative to an edge of component 202 may be selected to achieve a desired overflowed weld ring. In one embodiment, element 410 may be positioned closer to the outside edge than the inside edge. In other embodiments, element 410 may be positioned equidistant between the inside and outside edges or closer to the inside edge than the outside edge.

The position and shape of flow control element 410 may depend on the design of the interface regions of components 202 and 204. For example, the interface regions of components 202 and 204 may be designed to have a channel that directs melt material toward the outer surface. As another example, the interface regions may be designed so that no air bubbles form in the overflowed weld ring. As yet a further example, the interface regions may be designed to ensure that any gap or channel existing between components 202 and 204 is filled with melt material.

In order to facilitate directional control over melt flow, a high precision ultrasonic welder may be used. The welder may be controlled by high precision motors that can pitch, rotate, and move a sonotrode to desired locations. The welder can reposition the sonotrode to ensure the melt flows in a desired direction.

Referring now to FIG. 5, a cross-sectional view of headphone 500 is shown with top and bottom components 202 and 204 welded together in accordance with an embodiment of the invention. Also shown is overflow weld ring 515. Overflow weld ring 515 completely covers the junction between components 202 and 204 and is substantially devoid of air bubbles. In addition, weld ring 515 fills any gap (shown in dashed circle 520) existing between components 202 and 204. The weld ring's coverage is deliberately excessive to ensure the junction and any gaps are fully filled in.

Overflow weld ring 515 is ground down through a series of material removal steps. The material removal steps begin with a relatively coarse reduction of material and each subsequent step uses a finer degree of material reduction than the previous step. After the final step is completed, the junction between components 202 and 204 appears to be seamless. These steps are now discussed.

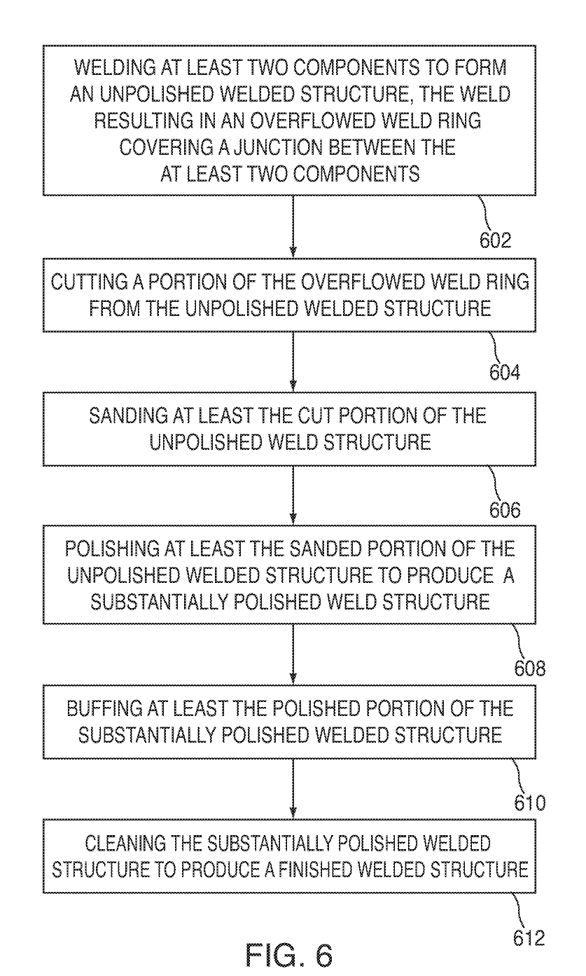

FIG. 6 shows illustrative steps for making a headphone in accordance with an embodiment of the invention. Starting at step 602, at least two components are welded together to form an unpolished welded structure. The weld results in an overflowed weld ring that covers a junction between the at least two components. The at least two components are constructed from a plastic material and may be joined together to form any suitable structure. For example, the components may be joined together to form a headphone enclosure. As another example, the two components may form an enclosure such as a box-shaped enclosure that encompasses various electronics.

At step 604, a portion of the overflowed weld ring is cut. A cutting tool, such as a CNC machine, may perform the cutting of the weld ring. The weld ring and potentially a portion of one or more of the components may be cut to a predetermined size. For example, if the end product of the welded structure is a headphone, the cutting tool can cut the overflowed weld ring down to size to match predetermined dimensions of the headphone. The cutting tool may, however, leave cutter marks on the components. These cutter marks can be removed by sanding the cut portions, as indicated by step 606. Sanding may be performed, for example, with a sand belt.

At step 608, the sanded portion is polished to remove additional material and to further smooth out the junction between at least two components. Varying degrees of polishing may be applied, ranging from a rough polish to a fine polish. In one embodiment, a sequence of rough, semi-rough, and fine polishes may be applied. After the final application of polish is applied, all or substantially all material that is to be removed has been removed.

At step 610, the polished portion is buffed. If desired, the components may also be buffed. This can result in a welded structure having a lustrous and smooth finish. Finally, at step 612, the welded structure is cleaned.

It should be understood that steps in FIG. 6 are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A welded structure, comprising:
a top component; and
a bottom component welded to the top component at a junction existing between the top and bottom components, wherein the junction is covered by a polished weld ring that seamlessly blends the top and bottom components together.

2. The welded structure of claim 1, wherein the top and bottom components are constructed from a plastic material.

3. The welded structure of claim 2, wherein the top and bottom components are constructed from the same plastic material.

4. The welded structure of claim 2, wherein the top and bottom components are constructed from different plastic materials.

5. The welded structure of claim 1, wherein the top and bottom components are ultrasonically welded together.

6. The welded structure of claim 1, further comprising circuitry contained within the bottom component.

7. The welded structure of claim 1, wherein the top component is a headphone cap and the bottom component is a headphone housing.

8. The welded structure of claim 7, wherein the headphone cap comprises at least one port.

9. The welded structure of claim 1, wherein the polished weld ring is derived from at least one of the top component and the bottom component.

10. The welded structure of claim 1, wherein, prior to being welded, the top component comprises a flow control element.

11. The welded structure of claim 10, wherein the flow control element exists as a continuous structure located at a predetermined location on an interface region of the top component.

12. The welded structure of claim 10, wherein the flow control element exists as a series of discrete structures located at predetermined locations on an interface region of the top component.

13. The welded structure of claim 11, wherein, prior to being welded, the bottom component comprises a flow control element.

14. A method for making a welded structure, comprising:
ultrasonically welding two plastic components together, wherein the welding produces an unpolished welded structure having an overflowed weld ring around a junction of the two plastic components;
cutting a portion of the unpolished welded structure to a predetermined size, the cutting includes removing a portion of the overflowed weld ring;
sanding at least the cut portion of the unpolished welded structure; and
polishing at least the sanded portion of the unpolished welded structure to produce a substantially polished welded structure.

15. The method of claim 14, further comprising:
buffing at least the polished portion of the substantially polished welded structure.

16. The method of claim 15, further comprising:
cleaning the substantially polished welded structure to produce a finished welded structure.

17. The method of claim 14, wherein the polishing comprises:
applying a relatively rough polish;
applying a semi-rough polish; and
applying a fine polish.

18. The method of claim 14, wherein the ultrasonically welding comprises melting a portion of one or both of the components, wherein the melting portion flows outward to form the overflowed weld ring.
